(19) United States
(12) Patent Application Publication
(10) Pub. No.: US 2019/0277947 A1
(43) Pub. Date: Sep. 12, 2019

(54) TRACKING APPARATUS AND TRACKING METHOD

(71) Applicant: Panasonic Intellectual Property Management Co., Ltd., Osaka (JP)

(72) Inventors: Takayuki ABE, Kanagawa (JP); Hidekuni YOMO, Kanagawa (JP)

(21) Appl. No.: 16/286,227

(22) Filed: Feb. 26, 2019

(30) Foreign Application Priority Data
Mar. 12, 2018 (JP) 2018-043960
Nov. 22, 2018 (JP) 2018-219603

(51) Int. Cl. G01S 7/48; G01S 17/66

(52) U.S. Cl. CPC G01S 7/4802; G01S 17/66

(57) ABSTRACT

A tracking apparatus includes a processor circuit that derives a center of gravity of point group data obtained from reflected waves reflected by a target reflecting radar waves, that finds a position in horizontal direction of the center of gravity, that determines a posture of the target from a distribution in at least either vertical or horizontal direction of the point group data, that, in a case where the position found and the posture determined satisfy predetermined conditions, analyzes a Doppler distribution of the target, and that assess a state of the target.

### BACKGROUND

### 1. Technical Field

The present disclosure relates to a tracking apparatus and a tracking method.

### 2. Description of the Related Art

In recent years, along with a declining birthrate and aging population and the trend toward the nuclear family, watching services have come to attention. A watching service is a service that notifies elderly people's families and young children's parents, who are administrators of the watching service, of the living conditions of elderly people living alone and young children of two-income households.

As an example of a technology that can be applied to a watching service, a physical object detection system involving the use of a laser radar is known (Japanese Unexamined Patent Application Publication No. 2015-114261). The physical object detection system described in Japanese Unexamined Patent Application Publication No. 2015-114261 horizontally scans a physical object with a laser radar at each angle of elevation and acquires scan data at each angle of elevation. Next, by comparing the scan data thus acquired with a feature model obtained from scan data of a pedestrian at each angle of elevation acquired in advance, the physical object detection system judges whether the physical object is a pedestrian.

### SUMMARY

However, in order to horizontally scan a physical object with a laser radar at each angle of elevation, the physical object detection system described in Japanese Unexamined Patent Application Publication No. 2015-114261 has a laser radar installed for each particular positional relationship regarding the distance and angle between the laser radar and a pedestrian. Accordingly, the installation of a plurality of laser radars tends to invite an increase in introduction cost.

One non-limiting and exemplary embodiment provides a tracking apparatus and a tracking method that make it possible to reduce the number of radar devices that are installed.

In one general aspect, the techniques disclosed here feature a tracking apparatus including a processor circuit that derives a center of gravity of point group data obtained from reflected waves reflected by a target reflecting radar waves, that finds a position in horizontal direction of the center of gravity, that determines a posture of the target from a distribution in at least either vertical or horizontal direction of the point group data, that, in a case where the position found and the posture determined satisfy predetermined conditions, analyzes a Doppler distribution of the target, and that assess a state of the target.

The present disclosure makes it possible to reduce the number of radar devices that are installed.

It should be noted that general or specific embodiments may be implemented as a system, an apparatus, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram showing a rough sketch of a tracking system of the present disclosure;

FIG. 2 is a block diagram of a tracking system according to Embodiment 1;

FIG. 3 is a flow chart showing an example of the tracking system according to Embodiment 1;

FIG. 4 is a diagram showing a process of obtaining height information in Embodiment 1;

FIG. 5 is a flow chart showing another example of the tracking system according to Embodiment 1;

FIG. 6 is a diagram explaining examples of variations in height by walking;

FIG. 7 is a diagram showing examples of variations in walking speed according to age and sex;

FIG. 8 is a diagram showing an example of installation of a radar device according to Embodiment 4;

FIG. 9 is a diagram showing a block configuration of a tracking system according to Embodiment 4;

FIG. 10 is a diagram showing a block configuration of a tracking system according to Embodiment 4; and

FIG. 11 is a diagram showing an example of a hardware configuration of a computer.

### DETAILED DESCRIPTION

Embodiments of the present disclosure are described in detail below with reference to the drawings.

### Embodiment 1

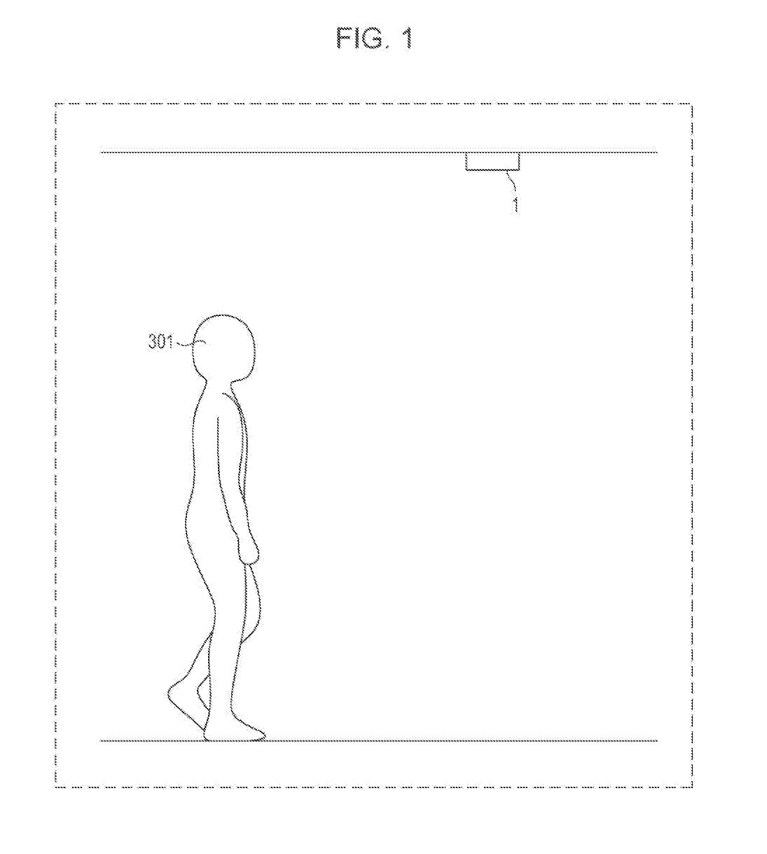

FIG. 1 is a diagram showing a rough sketch of a tracking system 1 of the present disclosure. The tracking system 1 judges whether a subject to be tracked (subject of tracking) 301 is a particular individual, further tracks a subject of tracking 301 judged to be the particular individual, and outputs the state of the subject of tracking 301.

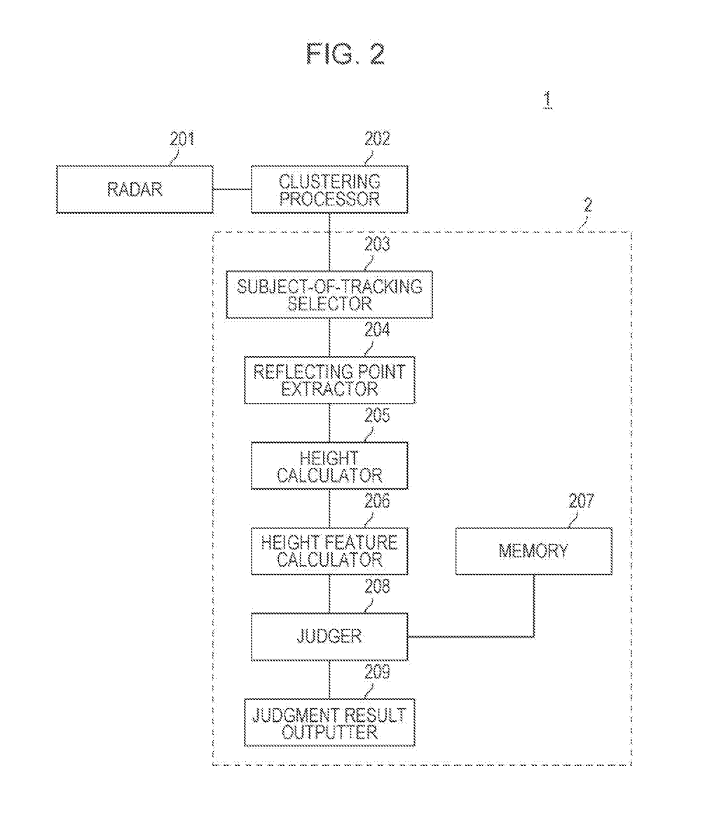

FIG. 2 is a block diagram of a tracking system 1 according to Embodiment 1. The tracking system 1 includes a radar 201, a clustering processor (clustering processor circuit) 202, and a tracking apparatus 2. The tracking apparatus 2 includes a subject-of-tracking selector (subject-of-tracking selection circuit) 203, a reflecting point extractor (reflecting point extraction circuit) 204, a height calculator (height calculation circuit) 205, a height feature calculator (height feature calculation circuit) 206, a memory (memory circuit) 207, a judger (judgment circuit) 208 (all of which constitute a processor circuit), and a judgment result outputter (judgment result output circuit or output circuit) 209.

The radar 201 emits radar waves toward subjects around the radar 201 and, by measuring reflected waves from the subjects, measures the distance and angle to each reflecting point (point) on the subjects.

In one example, the radar 201 is a laser radar that uses laser beams as radar waves. For example, the radar 201 is a pulse radar that uses pulse waves as a means of modulation or a continuous-wave radar that uses continuous waves as a means of modulation. In one example, the radar 201 is a Doppler radar that is able to measure the moving speed of a subject. In one example, the radar 201 is one that is capable of detecting the distance to a physical object and angles in horizontal direction and vertical direction.

In one example, the radar 201 is installed on a ceiling indoors, and emits radar waves downward. In another example, the radar 201 is installed on a utility pole outdoors, and emits radar waves downward. In another example, the radar 201 is installed on a floor surface (reference surface) indoors or on a ground surface (reference surface) outdoors, and emits electromagnetic waves upward. For example, the electromagnetic waves are millimeter waves. In this case, the radar 201 is a millimeter-wave radar device.

The clustering processor 202 performs a clustering process by extracting, from all reflecting point groups acquired from the radar 201, a reflecting point group for each subject to be detected and gathering the reflecting points as a duster (group). For example, the clustering processor 202 gathers, as a duster, reflecting points whose amounts of change in distance with respect to the amounts of change in angle to the reflecting points are equal to or smaller than a predetermined threshold.

The subject-of-tracking selector 203 selects a subject (subject of tracking, target) to be tracked in each duster acquired from the clustering processor 202. For example, the subject-of-tracking selector 203 can select a subject of tracking with reference to speed information on a duster of reflecting point groups.

The reflecting point extractor 204 extracts, from among reflecting point groups on the subject of tracking, a reflecting point that satisfies a predetermined condition. In one example, the predetermined condition is to be at the shortest distance from the radar 201. In another example, the predetermined condition is to be at the longest distance from the radar 201.

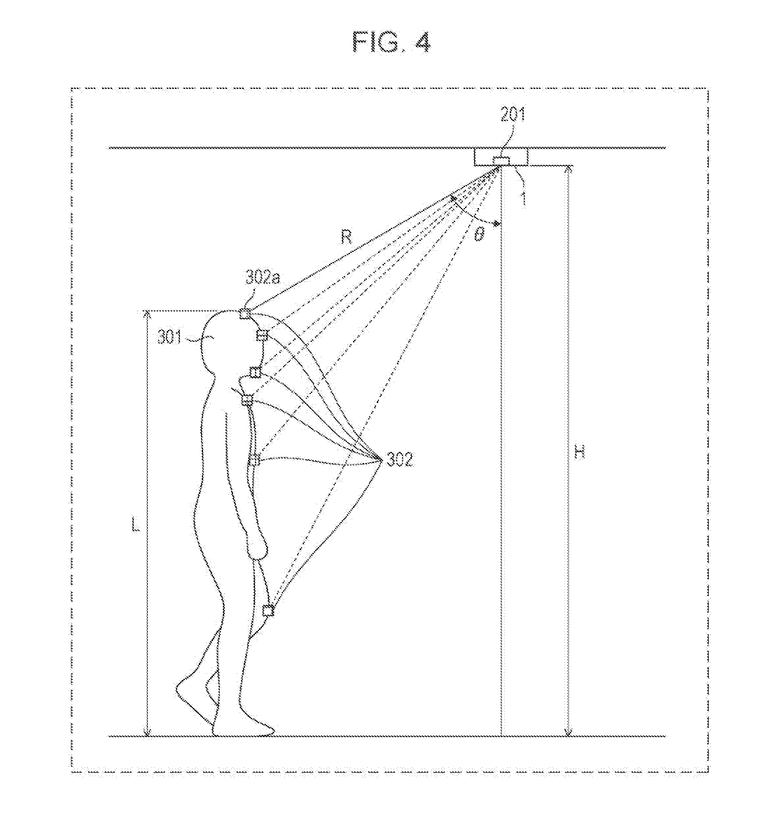

The height calculator 205 calculates a feature in vertical direction of the subject of tracking from the distance and angle obtained from the reflecting point extracted by the reflecting point extractor 204 and the installation position of the radar 201. Note here that the feature in vertical direction is for example a value of height. Although the following description takes the value of height as an example of the feature in vertical direction for the sake of ease, a value other than the value of height may be used as the feature in vertical direction. A method for calculating a value of height will be described in detail later with reference to FIG. 4.

The height feature calculator 206 calculates a feature (height feature) regarding a height of the subject of tracking on the basis of the value of height calculated by the height calculator 205. The height feature is at least one of the value of height, the average of heights, and a distribution of heights. The distribution is for example a histogram or a variance. In one example, the height feature calculator 206 calculates the average of heights or the distribution of heights on the basis of a plurality of values of height of the same subject of tracking as outputted from the height calculator 205 over a predetermined period of time or number of times.

The memory 207 has stored therein height information (information regarding a target) associated with a subject to be identified (subject of identification). In one example, the subject of identification is an individual that the tracking system 1 identifies. In another example, the subject of identification is an age bracket that the tracking system 1 identifies. In another example, the subject of identification is a sex that the tracking system 1 identifies. The height information contains a height feature of the subject of identification.

In one example, the tracking system 1 includes an interface (not illustrated) where a user inputs a name of a subject of identification and height information associated with the subject of identification, and the memory 207 stores therein the name of the subject of identification and the height information associated with the subject of identification as inputted by the user.

The judger 208 determines or judges, on the basis of the height feature outputted from the height feature calculator 206 and the height information stored in the memory 207, whether the subject of tacking is the subject of identification. In a case where the height feature is the value of height, the value of height calculated by the height calculator 205 may be used instead of the height feature outputted from the height feature calculator 206. For example, the judger 206 judges by comparison whether a difference between two features regarding the value of height is smaller than a threshold and, in a case where the difference is smaller than the threshold, judges that the subject of tracking is the subject of identification. For the sake of ease, “determining or judging that the subject of tracking is the subject of identification” is hereinafter simply referred to as “identifying the subject of tracking”.

In one example, after the judger 208 has judged the subject of tracking, the judger 208 updates, with reference to the value of height outputted from the height calculator 205 or the height feature outputted from the height feature calculator 206, the height information stored in the memory 207. This update process, performed by the judger 208, makes it possible to save the user the trouble of updating the height information in accordance with a temporal change in height feature of the subject of identification.

The judgment result outputter 209 outputs a result of determination or judgment (determination result or judgment result) made by the judger 208. The output is at least one of, for example, a notification, a display, and a sound. In one example, the judgment result outputter 209 includes a wire transmitter or a radio transmitter and notifies another device (not illustrated) such as an alarm device of the judgment result via the wire transmitter or the radio transmitter. In another example, the judgment result outputter 209 displays or sounds an alarm according to the judgment result.

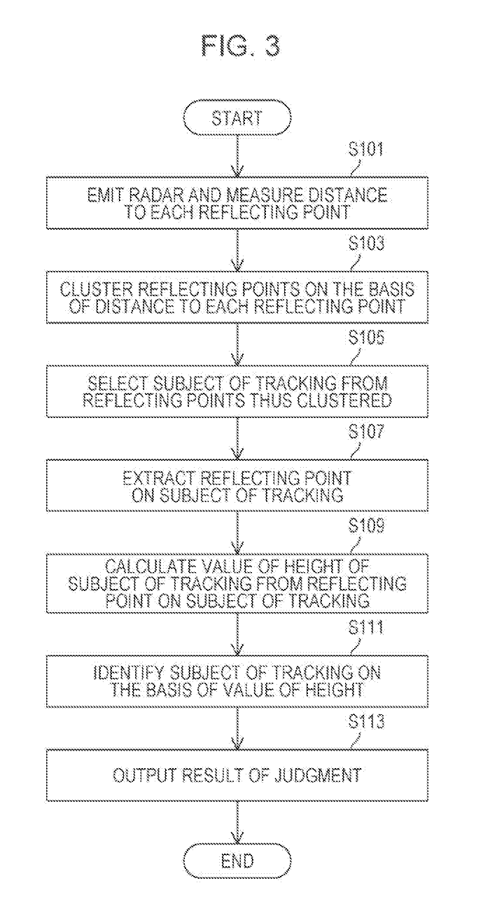

FIG. 3 is a flow chart showing an example of the tracking system 1 according to Embodiment 1. FIG. 4 is a diagram showing a process of obtaining height information in Embodiment 1.

In step S101, the radar 201 of the tracking system 1 irradiates a subject of tracking 301 with electromagnetic waves (radar waves) and measures the distance to each reflecting point 302 on the subject of tracking 301. As shown in FIG. 4, the electromagnetic waves emitted from the radar 201 strike the subject of tracking 301 and are reflected at each reflecting point 302 back to the radar 201. The radar 201 measures the distance to each reflecting point 302 on the subject of tracking 301 on the basis of the reflected waves thus received.

In step S103, the clustering processor 202 performs a clustering process on the reflecting points 302 on the basis of the distance to each reflecting point 302.

In step S105, the subject-of-tracking selector 203 selects a subject of tracking from clustered reflecting points 302. For example, as shown in FIG. 4, the subject-of-tracking selector 203 selects the subject of tracking 301 from the reflecting points 302.

In step S107, the reflecting point extractor 204 extracts a reflecting point 302a on a subject of tracking. For example, the reflecting point extractor 204 extracts, from among the reflecting points 302 on the subject of tracking 301 shown in FIG. 4, a reflecting point 302a that is at the shortest distance from the radar 201.

In step S109, the height calculator 205 calculates a height feature of the subject of tracking on the basis of the reflecting point 302a extracted by the reflecting point extractor 204. For example, let it be assumed that, as shown in FIG. 4, R is the distance between the reflecting point 302a, which is at the shortest distance from the radar 201, and the radar 201 and θ is the angle formed between the directional vector from the radar 201 to the reflecting point 302a and a downward vertical direction. Furthermore, let it be assumed that H is the distance between the radar 201 and the floor surface (reference surface). In this case, the height calculator 205 can employ H−R cos θ as the value of the height L of the subject of tracking 301 or an approximate value thereof. Note here that the value of H may be inputted to the height calculator 205 in advance, or may be acquired in advance with use of the radar 201.

In step S111, the judger 208 identifies the subject of tracking with reference to a height outputted from the height calculator 205 and height information stored in the memory 207. For example, in a case where the height L of the subject of tracking 301 shown in FIG. 4 matches a height L contained in height information stored in the memory 207 and the height information is associated with an individual A, who is a subject of identification, the judger 208 judges that the subject of tracking 301 is the individual A.

In step S113, the judgment result outputter 209 notifies another device (not illustrated) of a result of judgment yielded by the judger 208. For example, in a case where the judger 208 has judged that the subject of tracking 301 shown in FIG. 4 is the individual A, the judgment result outputter 209 wirelessly notifies another device that the subject of tracking 301 is the individual A.

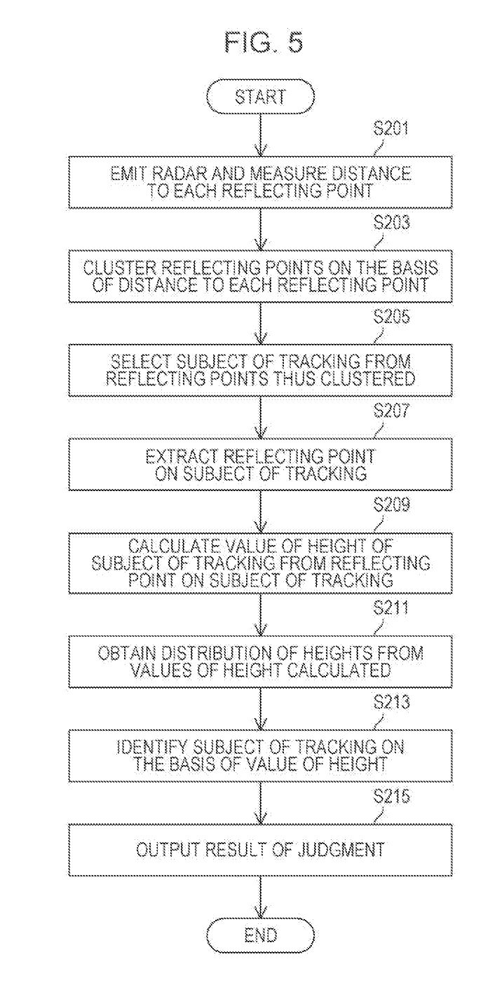

FIG. 5 is a flow chart showing another example of the tracking system 1 according to Embodiment 1.

Contents of processing of steps 201, S203, S205, S207, S209, and S215 are identical to those of steps S101, S103, S105, S107, S109, and S113, respectively, and, as such, are not described below.

In step S211, the height feature calculator 206 obtains, as a height feature, a distribution of heights calculated.

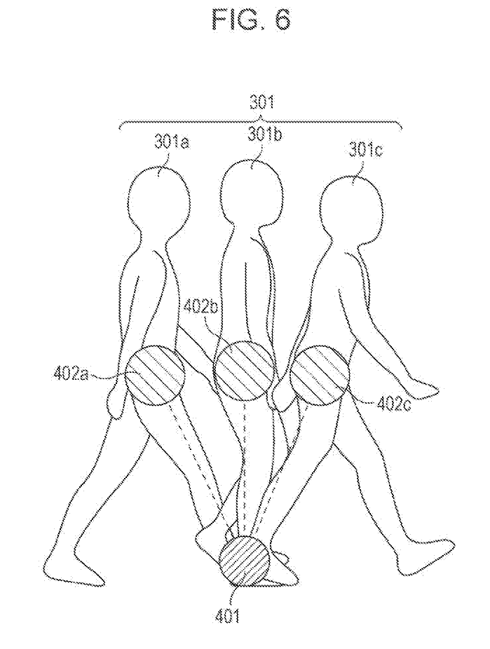

FIG. 6 is a diagram explaining examples of variations in height by walking. As shown in FIG. 6, since a human who is the subject of tracking 301 is walking, subjects of tracking 301a, 301b, and 301c vary in position from one another. In this case, the human makes a shift in center of gravity from 402a to 402c through 402b as he/she walks so that the center of gravity 402b is at the highest with a support 401 at the center. As a result, heights that are calculated vary along with walking so that the subject of tracking 301b is highest.

Further, patterns of the shift in center of gravity from 402a to 402c through 402b vary from individual to individual, from age bracket to age bracket, or from sex to sex. For example, the height feature calculator 206 acquires more than one heights outputted from the height calculator 205 and takes the average and variance of the plurality of height thus acquired.

In step S213, the judger 208 identifies the subject of tracking on the basis of the distribution of heights. For example, the memory 207 has the average and distribution of heights of the subject of identification stored as height information in advance therein. The judger 208 identifies the subject of tracking by comparing the average and variance outputted by the height feature calculator 206 with the height information of the subject of identification stored. Concomitant use of the variance enables the judger 208 to more accurately identify the subject of tracking than in a case where the variance is not used. For example, a plurality of individuals who are equal in average of heights can be identified on the basis of a difference in variance.

Thus, in one example, the tracking system 1 according to the present disclosure has its radar 201 installed on the ceiling, calculates a height feature of a subject of tracking, and identifies the subject of tracking on the basis of the height feature. Since the tracking system 1 according to the present disclosure is capable of identifying an individual in a line-of-sight coverage with the radar 201, the installation of the radar 201 on the ceiling makes it possible to reduce the number of radar devices that are installed, and makes it possible to lower introduction cost. Installing a plurality of the radars 201 makes it possible to cover subjects of tracking in a wider area.

Further, the tracking system 1 according to the present disclosure also makes it possible to judge whether a subject detected is a particular individual.

For example, there is a simple watching service, based on the pressing of a button of a household electric appliance by a subject of watching, in which an administrator confirms the safety of the subject of watching on the basis of notification of operating time from the household electric appliance. However, with such a means, the administrator has no way of knowing the living condition of the subject of watching unless the subject of watching presses the button. This makes it difficult for the administrator to obtain highly precise information sufficient for watching on the state of the subject. On the other hand, the tracking system 1 according to the present disclosure can identify and track a subject of watching without the subject of watching, who is a subject of tracking 301, needing to operate the tracking system 1. This makes it possible to obtain highly precise information sufficient for watching.

In one example, at the time of introduction, the tracking system 1 according to the present disclosure judges a subject of tracking by using the average of heights as a height feature. Next, after introduction, the judger 208 may, whenever needed, update height information stored in the memory 207 and, by using as a feature the height information thus updated, judge whether a subject of tracking 301 is a subject of identification. By changing from using one feature at the time of introduction to using another feature after introduction, the tracking system 1 according to the present disclosure is updated whenever needed after introduction and is capable of enhancing the precision with which to judge a subject of tracking 301.

In one example, even after having judged a subject of tracking 301, the tracking system 1 according to the present disclosure continues to track the subject of tracking 301 with reference to the output from the subject-of-tracking selector 203. This allows the tracking system 1 to continue to track the subject of tracking 301 even when it is difficult to calculate the full height of the subject of tracking 301, e.g. when the subject of tracking 301 stands upright, sits, or lies.

Further, for example, it is possible to identify the state of a subject of tracking 301 by using a value L calculated by the height calculator 205 as the height of the subject of tracking 301 after having judged that the subject of tracking 301 is a subject of identification. For example, the judger 208 compares the value L with a threshold determined on the basis of the full height of the subject of tracking 301 and identifies the state of the subject of tracking 301 according to a result of the comparison. This makes it possible to collect data regarding the current action of the subject of tracking 301.

### Embodiment 2

The tracking system 1 according to Embodiment 1 calculates the height of a subject of tracking 301 with reference to one of reflecting points 302 on the subject of tracking 301 as measured by the radar 201, e.g. a reflecting point 302a that is at the shortest distance. On the other hand, a tracking system 1 according to Embodiment 2 calculates a feature of a subject of tracking 301 with reference to more than one of reflecting points measured by the radar 201.

For example, for each azimuth in horizontal direction of the radar 201, the reflecting point extractor 204 extracts, from among the reflecting points 302 on the subject of tracking 301 as measured by the radar 201, a reflecting point that is at the shortest distance. Next, in a manner similar to Embodiment 1, the height calculator 205 calculates the height with reference to that one of those reflecting points thus extracted which is at the shortest distance. Furthermore, the height calculator 205 calculates H₂=R₂*cos θ₂ as the height of the shoulders with reference to the distance R₂ to that one of those reflecting points extracted by the reflecting point extractor 204 which is at the longest distance and the angle θ₂ formed between the directional vector from the radar 201 to that reflecting point and a downward vertical direction. In addition to height features, the judger 208 compares features regarding the height of the shoulders in a manner similar to the height features. This makes it possible to enhance the precision with which to identify the subject of tracking 301.

### Embodiment 3

The tracking system 1 according to Embodiment 1 uses the distance and angle to each reflecting point 302 measured by the radar 201. On the other hand, a tracking system 1 according to Embodiment 3 further uses the moving speed of each reflecting point 302. In Embodiment 3, the radar 201 is a radar that is able to measure the moving speed of a reflecting point, e.g. a Doppler radar.

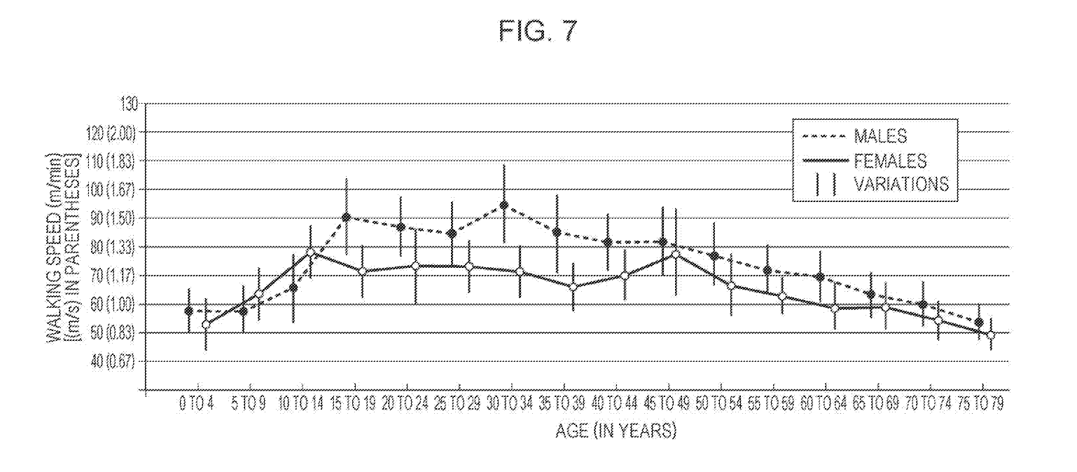

FIG. 7 is a diagram showing examples of variations in walking speed according to age and sex. FIG. 7 shows a graph plotted with filled circles representing the average walking speed of males and open circles representing the average walking speed of females. Further, line segments drawn above and below the filled or open circles represent variations in walking speed.

As shown in FIG. 7, there are reasonable variations in walking speed according to age and sex. Further, there are also variations from individual to individual. To address these conditions, Embodiment 3 is configured such that the judger 208 uses the moving speed of a subject of tracking 301 as a walking speed and identifies the subject of tracking 301 on the basis of a feature regarding the walking speed of the subject to tracking 301, e.g. at least one of the walking speed, the average of walking speeds, and a variance of walking speeds, in addition to a height outputted by the height calculator 205 or a height feature outputted by the height feature calculator 206. By thus further increasing the number of types of feature for use in identification of the subject of tracking 301, the precision with which to identify the subject of tracking 301 can be further improved.

### Embodiment 4

Embodiment 4 is configured, for example, to embody watching in a bathroom. A bathroom is an environment which can be filled with water vapor and where various places other than a human body may become about as high in temperature as the human body. This may make it difficult, for example, to apply an optical imaging device such as an infrared sensor. Meanwhile, a radar device is less affected, for example, by water vapor or temperature and, as such, has high affinity with a watching system that is applied to a bathroom or the like.

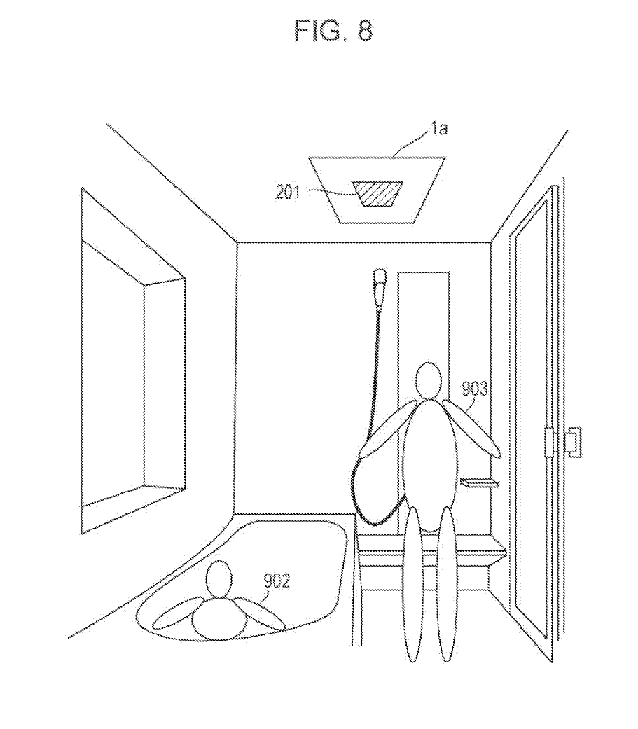

FIG. 8 is a diagram showing an example of installation of a tracking system 1a and a radar device 201 according to Embodiment 4. The radar 201 is for example a millimeter-wave radar. In FIG. 8, the tracking system la and the radar 201 are installed near a ceiling in a bathroom. FIG. 8 schematically shows a human subject of sensing 902 soaking in a bathtub and a human subject of sensing 903 standing outside the bathtub. As shown in FIG. 8, it is assumed in a household bathtub that one person (e.g. bather) is staying mainly in a region of washing place or in the bathtub. For use in watching of elderly people or the Ike, it is necessary to detect the bather drowning for example because he/she has fallen due to an accident or a sudden change in physical condition or has fainted due to a reduction in blood pressure while he/she is bathing alone. The tracking system la may have its radar 201 disposed in the bathroom and its other constituent elements installed outside the bathroom.

Meanwhile, in a case where an infant and its guardian bathe together, it is necessary to detect the infant falling in the bathtub during a short period of time when the guardian is off his/her guard and look away from the infant, for example, to wash his/her hair.

A bathers family waiting in a place different from the bathroom in which the bather is bathing gains a higher sense of reassurance from a system that, even under safe conditions, notifies the family in what place and in what posture (standing or sitting) the bather is acting than from a system that simply reports the aforementioned situation (drowning or falling). For example, in a case where the bather is soaking in the bathtub for a longer period of time than usual, the family can take precautionary measures, for example, by calling to the bather before the bather reaches a state of drowning.

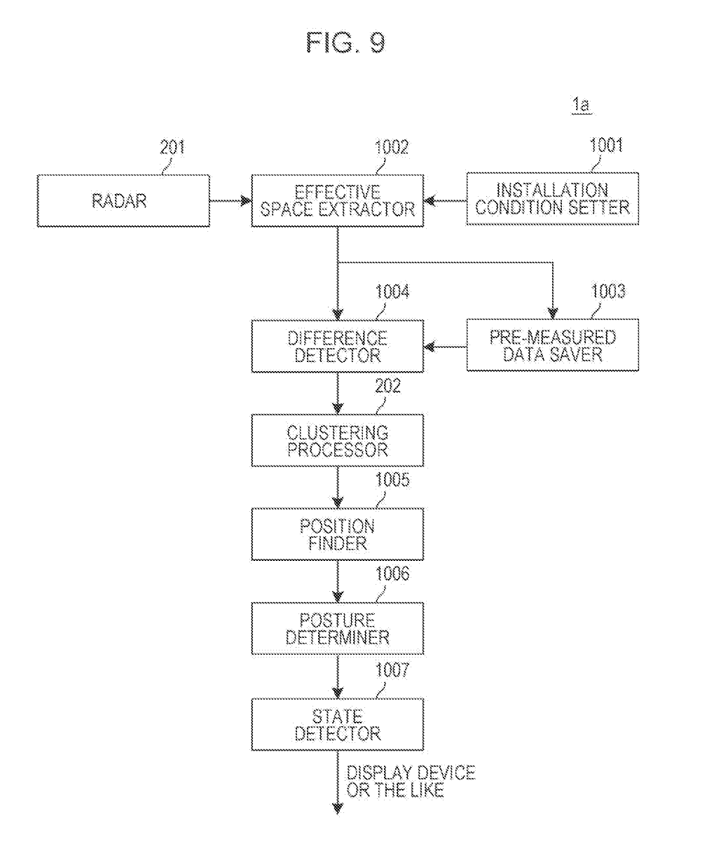

FIG. 9 is a diagram showing a block configuration of the tracking system 1a according to Embodiment 4. The tracking system la includes the radar 201, an installation condition setter 1001, an effective space extractor 1002, a pre-measured data saver 1003, a difference detector 1004, a clustering processor 202, a position finder 1005, a posture determiner 1006, and a state detector 1007.

The radar 201 outputs data containing information on the position, intensity, speed of a reflected signal. The radar 201 is identical to the radar 201 according to Embodiment 1 and is for example a millimeter-wave radar device. The installation condition setter 1001 sets the installation position and angle of the radar 201.

The radar 201 is affected by factors such as multiple reflection, multipath, and transmission through a wall of the bathroom that causes the radar 201 to be affected by a reflection object located at the back of the wall. Under such influences, reflected waves may be detected as if signals were reflected from places other than a bathroom space. To address these conditions, the effective space extractor 1002 finds an effective space in an orthogonal space in the bathroom according to the installation position and angle of the radar 201 as set by the installation condition setter 1001, extracts signals from an effective space region, and outputs the signals thus extracted to a later stage. The effective space extractor 1002 does not output signals other than the signals thus extracted to a later stage.

The pre-measured data saver 1003 for example saves measured data on reflected waves from static reflection objects such as the bathtub, a faucet, and a door knob as measured in advance in the absence of anyone in the bathroom. This enables the tracking system la to grasp the influence of the static reflection objects on the reflected waves.

The difference detector 1004 detects, on the basis of a difference between pre-measured data read out from the pre-measured data saver 1003 and output data that is inputted in real time from the effective space extractor 1002, a human body having entered the bathroom or an object moved to a place different from the place it was at the time of pre-measurement.

In one example, the pre-measured data saver 1003 saves results of pre-measurements in various states in addition to results of pre-measurements at particular moments. Moreover, the difference detector 1004 may select a result of a pre-measurement that is least different from a signal that is inputted in real time from the effective space extractor 1002. This makes it possible to reduce the influence that the difference detector 1004 receives from a discrepancy in state in the bathroom such as the amount of water with which the bathtub is filled, the open or dosed state of a lid, the installation direction and position of a shower nozzle, and the degree of dryness of the bathroom.

The clustering processor 202 dusters point groups on regions that can be deemed as a single entity.

The position finder 1005 derives the center of gravity of the point groups thus clustered. Next, the position finder 1005 decides, on the basis of the horizontal coordinates of the center of gravity in a three-dimensional orthogonal space, whether the bather is located in the bathtub or located in the washing place.

The posture determiner 1006 takes the variance (variation) of point groups in vertical direction and, in a case where the variance is greater than a predetermined threshold, determines that the bather is in a state of standing or, in other cases, determines that the bather is in a state of sitting.

The state detector 1007 detects whether the bather is in an abnormal state. Note here that the abnormal state is for example a state of drowning or a state of having fallen.

The state detector 1007 analyzes a Doppler frequency distribution of the point groups thus clustered, and in a case where, after the physical object (bather) has sit down, the state detector 1007 has judged that a motion of a part of the physical object (e.g. the head of the bather) is less active than a predetermined threshold, the state detector 1007 detects the bather being in a state of drowning. For example, in a case where the bather shifts from a state of being located in the bathtub and sitting or lying to a state of keeping his/her head further down or keeping his/her head bent, there is a higher risk of drowning than in other cases. Accordingly, in one example, the state detector 1007 detects the bather being in a state of drowning according to a result of decision yielded by the position finder 1005 and/or a result of determination yielded by the posture determiner 1006. The state detector 1007 may determine the presence of a state of drowning after a certain period of time (first period of time, e,g, two minutes) has elapsed since the bather had his/her head down or had his/her head bent.

An operation that follows the sitting down of the bather in the bathtub is described.

In case where a predetermined period of time has elapsed, the state detector 1007 may determine the presence of a state of long-time bathing and notify a display device accordingly, even if the physical object keeps sitting and a part of the physical object (e,g the head of the bather) is less active than the predetermined threshold,

Note here that after the sitting down of the bather in the bathtub, the influence of water in the bathtub causes the clustering processor 202 to output a duster of point groups in an area around the head of the bather. The position finder 1005 derives the center of gravity of the duster of point groups in the area around the head. The posture determiner 1006 assesses, with reference to the center of gravity thus derived of the duster of point groups in the area around the head, whether the bather has had his/her head further down or further bent after sitting down.

Further, in a case where the bather quickly changes his/her posture from a state of standing or a state of sitting in the washing place, there is a possibility that the bather may have fallen. Accordingly, in one example, the state detector 1007 determines the magnitude of a difference between a duster of point groups included in several frames acquired before the current frame, i.e. several frames acquired within a predetermined period of time (second period of time, e.g. 5 seconds) before the current time, and a duster of point groups included in the current frame and, in a case where the magnitude is equal to or greater than a predetermined threshold, judges that the bather has fallen. In a case where the bather does not shift to a state of standing or a state of sitting even if a certain period of time (third period of time, e.g. one minute) has elapsed since the state detector 1007 judged that the bather had fallen, the state detector 1007 detects the bather being in a state of having fallen.

In a case where the state detector 1007 has detected the bather being in an abnormal state, the state detector 1007 reports the occurrence of an emergency situation, for example, by instructing a later-stage display device to raise an alarm such as an alarm sound or an alarm display.

On the other hand, in a case where the state detector 1007 has not detected the bather being in an abnormal state, the state detector 1007 may instruct the later-stage display device or the like to display the position and posture of the bather. In accordance with the instructions, the later-stage display device or the like displays the conditions of the bather. Such display devices may be installed both inside and outside the bathroom.

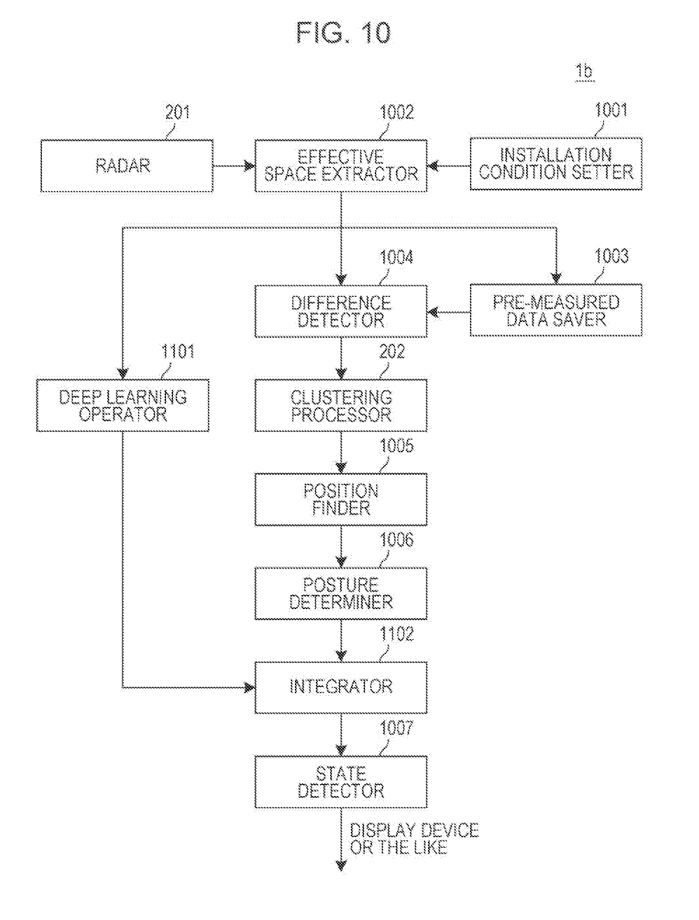

FIG. 10 is a diagram showing a block configuration of a tracking system 1b according to Embodiment 4. The tracking system 1b differs from the tracking system 1a in terms of including a deep learning operator 1101 and an integrator 1102 and in terms of a part of the content of processing of the state detector 1007. As for the points that the tracking system 1b has in common with the tracking system 1a, the tracking system 1b is not described below.

The deep learning operator 1101 learns states of the bather with reference to previous measured data and classifies input signals according the states of the bather. The deep learning operator 1101 includes, for example, a recurrent neural network. Examples of the states of the bather that are learned and classified include a state of sitting in the bathroom, a state of standing in the bathroom, a state of sitting in the washing place region, and a state of standing in the washing place region. In one example, the states of the bather that are learned and classified further include abnormal states (e.g. a state of drowning and a state of having fallen) and other states (e.g. a normal state).

In one example, the tracking system 1b including the deep learning operator 1101 learns and classifies the states of the bather including the influence of static reflection objects. For example, as shown in FIG. 10, the deep learning operator 1101 receives effective space region signals from the effective space extractor 1002 and uses the received signals in learning and classification.

The integrator 1102 receives signals from the posture determiner 1006 and the deep learning operator 1101. For example, in the case of an initial state where the deep learning operator 1101 has not sufficiently learned, the integrator 1102 selects a signal received from the posture determiner 1006 and outputs it to the later-stage state detector 1007.

Meanwhile, for example, in a case where the deep learning operator 1101 has sufficiently learned, the integrator 1102 integrates a signal inputted from the posture determiner 1006 and a signal inputted from the deep learning operator 1101 and outputs a signal to the later-stage state detector 1007 on the basis of the signals thus integrated. In one example, upon receiving from the deep learning operation 1101 a signal indicating the classification of an abnormal state, the integrator 1102 outputs to the later-stage state detector 1007 a signal designating a process that is executed upon detection of an abnormal state. In accordance with the signal from the integrator 1102, the state detector 1007 may execute the process, described with reference to FIG. 9, that is executed upon detection of an abnormal state.

In another example, in a case where the deep learning operator 1101 has classified the state of the bather as an abnormal state and the posture determiner 1006 has determined that the bather is sitting in the bathtub, the integrator 1102 may output a signal that instructs the later-stage state detector 1007 to detect whether the bather is in the abnormal state. In accordance with the signal from the integrator 1102, the state detector 1007 may detect whether the bather is in the abnormal state. Further, in other cases, the integrator 1102 may output to the later-stage state detector 1007 a signal designating a process that is executed in the absence of detection of an abnormal state. In accordance with the signal from the integrator 1102, the state detector 1007 may execute the process, described with reference to FIG. 9, that is executed in the absence of detection of an abnormal state.

### Modifications

The tracking system 1 according to the present disclosure is also applicable to a use different from a watching service. For example, the application of the tracking system 1 to transportation infrastructure such as a traffic signal or a utility pole makes it possible to judge, on the basis of a height feature, whether a subject of tracking 301 is a human or an animal or whether the subject of tracking 301 is an adult or a child. For example, upon receiving notification from the judgment result outputter 209 of the tracking system 1, the alarm device (not illustrated) may sound an alarm or blink a light according to the type and/or state of the subject of tracking 301. This makes it possible to apply the tracking system 1 to warning of a danger. Further, the application of the tracking system 1 to an office or a commercial facility makes it possible to detect the line of flow of a subject of tracking with its age bracket and sex specified.

Embodiments 1 to 4 have been described above by taking as an example a case where the whole tracking system 1 is for example installed as a single entity in one place on a ceiling or a utility pole. Alternatively, such an embodiment is conceivable that an apparatus including one or more of the constituent elements other than the radar 201 of the tracking system 1 may be installed as a separate entity from the tracking system 1 including the radar 201. In this case, the apparatus installed as a separate entity may communicate with the tracking system 1 via wire communication or radio communication.

Embodiment 4 uses deep learning in the learning and classification of states of a bather. Alternatively, such an embodiment is conceivable that another learning algorithm such as a support vector machine, clustering learning, or ensemble learning may be used in the learning and classification of states of a bather.

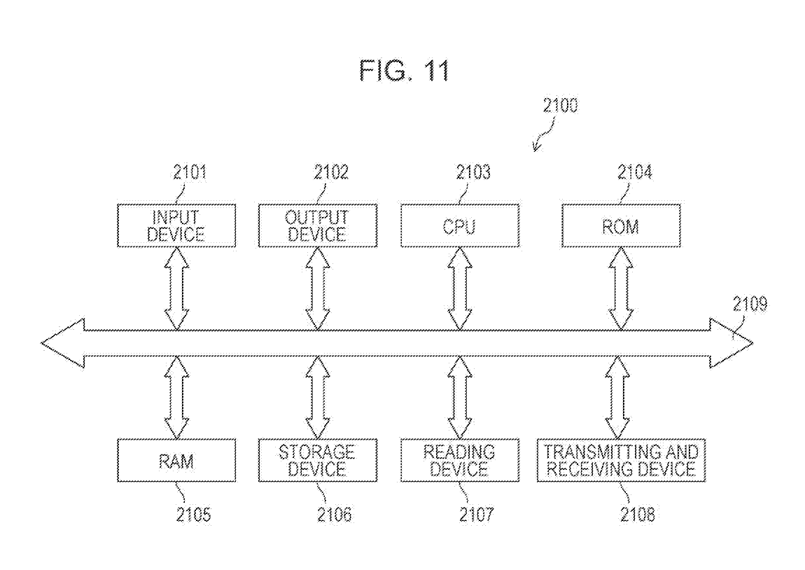

FIG. 11 is a diagram showing an example of a hardware configuration of a computer. The functions of each component in each of the embodiments and modifications described above are achieved by a program that a computer 2100 executes.

As shown in FIG. 11, the computer 2100 includes an input device 2101 such as an input button or a touch pad, an output device 2102 such as a display or a speaker, a CPU (central processing unit) 2103, a ROM (read-only memory) 2104, and a RAM (random-access memory) 2105. Further, the computer 2100 includes a storage device 2106 such as a hard disk device or an SSD (solid-state drive), a reading device 2107 that reads information from a storage medium such as a DVD-ROM (digital versatile read-only memory) or a USB (universal serial bus), and a transmitting and receiving device 2108 that performs communication via a network. Each of the components mentioned above is connected to the other via a bus 2109.

Moreover, the reading device 2107 reads, from a storage medium having stored thereon a program for achieving the functions of each of the components, the program and stores the program in the storage device 2106. Alternatively, the transmitting and receiving device 2108 performs communication with a server apparatus connected to the network, downloads from the server apparatus a program for achieving the functions of each of the components, and stores the program in the storage device 2106:

Moreover, the CPU 2103 copies into the RAM 2105 the program stored in the storage device 2106 and sequentially reads out from the RAM 2105 commands contained in the program, whereby the functions of each of the components are achieved. Further, in executing the program, the information obtained by the various types of processing described in each embodiment is stored in the RAM 2105 or the storage device 2106 and used as appropriate.

The present disclosure may be achieved with software, hardware, or software in cooperation with hardware. The functions of each of the components used to describe the embodiments above may be partly or wholly achieved as LSIs, which are integrated circuits, and each process described in the embodiments above may be partly or wholly controlled by a single LSI or a combination of LSIs. The LSIs may each be composed of individual chips, or may be composed of a single chip so as to include some or all of the functional blocks. The LSIs may each include an input and an output. Depending on the degree of integration, the LSIs may alternatively be referred to as “ICs”, “system LSIs”, “super LSIs”, or “ultra LSIs”, However, the technique of implementing an integrated circuit is not limited to LSI and may be achieved by using a dedicated circuit, a general-purpose processor, or a dedicated processor. In addition, an FPGA (field-programmable gate array) that can be programmed after the manufacture of an LSI or a reconfigurable processor in which the connections and the settings of circuit cells disposed inside an LSI can be reconfigured may be used. The present disclosure may be achieved as digital processing or analog processing. If future integrated circuit technology replaces LSI as a result of the advancement of semiconductor technology or other derivative technology, the functional blocks could be integrated using the future integrated circuit technology. For example, biotechnology can also be applied.

### Summary of the Embodiments

A tracking apparatus of the present disclosure includes: a processor circuit that calculates a feature of a target regarding a direction vertical to a reference surface on the basis of one of a plurality of pieces of distance information between each of a plurality of points on the target and a radar and that makes a determination of the target on the basis of the feature and information regarding the target associated with the feature, the plurality of pieces of distance information being obtained from reflected waves reflected by the target reflecting radar waves emitted from the radar, the radar being installed on the reference surface or in a position that is away from the reference surface in the direction vertical to the reference surface; and an output circuit that outputs a result of the determination of the target.

In tracking apparatus of the present disclosure, the reference surface is a floor surface of an interior of a room, and the position that is away from the reference surface in the direction vertical to the reference surface is a ceiling of the interior of the room.

In the tracking apparatus of the present disclosure, the radar measures a moving speed of the target, the information regarding the target contains a feature regarding the moving speed of the target, and the determination is further based on a comparison between the moving speed thus measured and the feature regarding the moving speed of the target as contained in the information regarding the target.

The tracking apparatus of the present disclosure further includes a clustering processor circuit that extracts the plurality of points on the target from the reflected waves.

In the tracking apparatus of the present disclosure, the processor circuit extracts, from among the plurality of points on the target, a point that is at a shortest distance from the radar.

In the tracking apparatus of the present disclosure, the feature is at least one of a value of height, an average of the height, and a variance of the height.

With respect to the target determined by the processor circuit, the tracking apparatus of the present disclosure estimates a state of the target on the basis of the feature.

The tracking apparatus of the present disclosure further includes a memory circuit that stores therein the information regarding the target. With respect to the target determined by the processor circuit, the tracking apparatus of the present disclosure updates, with the feature of the target, the information regarding the target stored in the memory circuit.

A tracking method of the present disclosure includes: calculating a feature of a target regarding a direction vertical to a reference surface on the basis of one of a plurality of pieces of distance information between each of a plurality of points on the target and a radar; making a determination of the target on the basis of the feature and information regarding the target associated with the feature, the plurality of pieces of distance information being obtained from reflected waves reflected by the target reflecting radar waves emitted from the radar, the radar being installed on the reference surface or in a position that is away from the reference surface in the direction vertical to the reference surface; and outputting a result of the determination of the target.

A tracking program of the present disclosure causes a processor to execute a process including; calculating a feature of a target regarding a direction vertical to a reference surface on the basis of one of a plurality of pieces of distance information between each of a plurality of points on the target and a radar; making a determination of the target on the basis of the feature and information regarding the target associated with the feature, the plurality of pieces of distance information being obtained from reflected waves reflected by the target reflecting radar waves emitted from the radar, the radar being installed on the reference surface or in a position that is away from the reference surface in the direction vertical to the reference surface; and outputting a result of the determination of the target.

A tracking apparatus of the present disclosure includes a processor circuit that calculates a feature of a target regarding a vertical direction on the basis of one of pieces of point group data obtained from reflected waves reflected by the target reflecting radar waves and that makes a determination of the target on the basis of the feature and information regarding the target associated with the feature.

The tracking apparatus of the present disclosure is installed above the target.

A tracking method of the present disclosure includes: calculating a feature of a target regarding a vertical direction on the basis of one of pieces of point group data obtained from reflected waves reflected by the target reflecting radar waves; and making a determination of the target on the basis of the feature and information regarding the target associated with the feature.

A tracking program of the present disclosure causes a processor to execute a process including: calculating a feature of a target regarding a vertical direction on the basis of one of pieces of point group data obtained from reflected waves reflected by the target reflecting radar waves: and making a determination of the target on the basis of the feature and information regarding the target associated with the feature.

A tracking apparatus of the present disclosure includes a processor circuit that derives a center of gravity of point group data obtained from reflected waves reflected by a target reflecting radar waves, that finds a position in horizontal direction of the center of gravity, that determines a posture of the target from a distribution in at least either vertical or horizontal direction of the point group data, that, in a case where the position found and the posture determined satisfy predetermined conditions, analyzes a Doppler distribution of the target, and that assess a state of the target.

In the tracking apparatus of the present disclosure, the processor circuit deducts an influence of a static reflection object measured in advance from the reflected waves.

In the tracking apparatus of the present disclosure, the processor circuit performs learning of the state of the target and classifies the state of the target with reference to a result of the learning.

In the tracking apparatus of the present disclosure, the state of the target is a drowning state of the target or a fallen state of the target.

In the tracking apparatus of the present disclosure, the predetermined conditions are conditions in which after the target has assumed a state of being located in a bathroom and sitting or lying, a position in vertical direction of the center of gravity of the point group data is kept down for a first period of time.

In the tracking apparatus of the present disclosure, the predetermined conditions are conditions in which a position in vertical direction of the center of gravity of the point group data changes within a second period of time from a state in which the target is standing or sitting and, for a third period of time, the target does not shift to a state of standing or a state of sitting.

The tracking apparatus of the present disclosure further includes a radar device that sends out the radar waves from above the target.

The tracking apparatus of the present disclosure further includes an output device that, in a case the processor circuit has determined that an abnormal state is present, indicates the abnormal state.

A tracking method of the present disclosure includes: deriving a center of gravity of point group data obtained from reflected waves reflected by a target reflecting radar waves; finding a position in horizontal direction of the center of gravity; determining a posture of the target from a distribution in at least either vertical or horizontal direction of the point group data; in a case where the position found and the posture determined satisfy predetermined conditions, analyzing a Doppler distribution of the target; and assessing a state of the target.

A tracking system according to the present disclosure is applicable to a system that identifies a subject of tracking by radar.

What is claimed is:

1. A tracking apparatus comprising a processor circuit that derives a center of gravity of point group data obtained from reflected waves reflected by a target reflecting radar waves, that finds a position in horizontal direction of the center of gravity, that determines a posture of the target from a distribution in at least either vertical or horizontal direction of the point group data, that, in a case where the position found and the posture determined satisfy predetermined conditions, analyzes a Doppler distribution of the target, and that assess a state of the target.

2. The tracking apparatus according to claim 1, wherein the processor circuit deducts an influence of a static reflection object measured in advance from the reflected waves.

3. The tracking apparatus according to claim 1, wherein the processor circuit performs learning of the state of the target and classifies the state of the target with reference to a result of the learning.

4. The tracking apparatus according to claim 1, wherein the state of the target is a drowning state of the target or a fallen state of the target.

5. The tracking apparatus according to claim 1, wherein the predetermined conditions are conditions in which after the target has assumed a state of being located in a bathroom and sitting or lying, a position in vertical direction of the center of gravity of the point group data is kept down for a first period of time.

6. The tracking apparatus according to claim 1, wherein the predetermined conditions are conditions in which a position in vertical direction of the center of gravity of the point group data changes within a second period of time from a state in which the target is standing or sitting and, for a third period of time, the target does not shift to a state of standing or a state of sitting.

7. The tracking apparatus according to claim 1, comprising a radar device that sends out the radar waves from above the target.

8. The tracking apparatus according to claim 1, comprising an output device that, in a case the processor circuit has determined that an abnormal state is present, indicates the abnormal state.

9. A tracking method comprising:
deriving a center of gravity of point group data obtained from reflected waves reflected by a target reflecting radar waves;
finding a position in horizontal direction of the center of gravity;
determining a posture of the target from a distribution in at least either vertical or horizontal direction of the point group data;
in a case where the position found and the posture determined satisfy predetermined conditions, analyzing a Doppler distribution of the target; and
assessing a state of the target.
